(19) United States
(12) Patent Application Publication
(10) Pub. No.: US 2007/0286181 A1
(43) Pub. Date: Dec. 13, 2007

(54) Remote home/office monitoring and control using Skype

(76) Inventors: Dennis Bushmitch, Somerset, NJ (US); Rajesh Khandelwal, Princeton Junction, NJ (US); David Alan Braun, Denville, NJ (US)

Correspondence Address: DENNIS BUSHMITCH, 183 MATLOOK PLACE, SOMERSET, NJ, 08873, US

(21) Appl. No.: 11/804,816

(22) Filed: May 21, 2007

Related U.S. Application Data
(60) Provisional application No. 60/808,050, filed on May 25, 2006.

(51) Int. Cl. H04L 12/66

(52) U.S. Cl. 370/356

(57) ABSTRACT

A method for monitoring and control of local or remote premises using a popular Skype™ peer-to-peer communication service is defined. The invented methodology provides for mobile surveillance and control using information infrastructure provided by Skype™ communicator. A combination of hardware and software methodologies utilizes voice, video and text message Skype™ communication channels to relate various sensory data and controls signals. This application is derived from the patent application 60/808,050 filed on May 25, 2006.

### BACKGROUND OF THE INVENTION

Skype is a popular peer-to-peer communication service which uses IP network connectivity to communicate via instant messages and voice or video calls between multiple parties. Due to its peer-to-peer distributed nature and attractive pricing, Skype has good scalability features and can support and attract a large number of users. Several hardware vendors presently integrate Skype connectivity into their telephone solutions. Skype applications presently run on a variety of PC and Linux-based computing platforms,

Remote premises monitoring and control is presently wide spread using specialized hardware and software applications and networks. SANSAPHONE device, for example, monitors temperature and sound levels at some installation, and then call several pre-programmed telephone numbers in case the alarm condition is being raised.

Communication of the alarm conditions typically requires the presence of the telephone network in its traditional or cellular forms. Industrial-strength applications may also utilize Internet-protocol based networks, and require highly-specialized control and monitoring applications that tend to be available to a select group of subscribers only.

Control and monitoring of the Mobile installations is presently a difficult problem, as the application-level mobility and support needs to be resolved. This limits the applicability and increases the associated costs with such monitoring applications.

Finally, monitoring and control of premises performed by mobile users (via smart phones, mobile phones, etc) is fairly limited toward highly specialized solutions utilizing expensive home networking gateways and dial-up monitoring stations or applications. Typically additional fees and limitations exerted by cell-phone operators further inhibit the use of these applications.

### SUMMARY OF THE INVENTION

The present invention is embodied in several software and hardware functional modules comprising the architecture for remote monitoring and control of various stationary and mobile installations using popular Skype peer-to-peer software.

According to one aspect of the invention, its several hardware and software components allow various environmental conditions from the monitored premises, like temperature change, continuity/discontinuity events and water leaks to be communicated over Skype instant message and voice communication services to a remote mobile Skype-based client.

According to another aspect of the invention, its software and hardware components allow for voice-based and instant-message based Skype-communicated information to be translated into control signals to be issued within remotely monitored and controlled installation, causing various devices and actuators to respond to commands issued by a remote monitoring and controlling Skype-based client user.

According to yet another aspect of this invention, its software and hardware components allow for multiple remotely monitored and controlled installations be monitored and controlled from a single given Skype-based communication device.

According to another aspect of the invention, a plurality of Skype-based monitoring and controlling applications can interact with controlled and monitored remote premises installation using Skype-based communication channel.

According to another aspect of this invention, voice-based commands can be translated into controlling events for remote premises installation, and status events detected at such premises can be translated back into voice-based communications to be sent to various users of the present invention.

According to yet another aspect of this invention, email-based communications and commands can be translated into controlling events for remote premises installation, and status, sensory-based events detected at such premises can be translated back into email-based communications to be sent to various users of the present invention by standard means of networking.

According to another aspect of this invention, Short Message Service (SMS)-based instructions can be translated into controlling events for remote premises installation, and status events detected at such premises can be translated back into SMS-based communications to be sent to various users of the present invention.

According to yet another aspect of this invention, sensory-based events detected at such premises can trigger video capture of the remote events, resulting in captured video archives to be sent to various users and monitored of the present invention via standard means of networking or Skype-based communication channel.

According to another aspect of this invention, detected events, alarms messages, as well as received over Skype text and graphics messages can also be displayed over a variety of home appliances with display capabilities, including that of marquee displays, audio alarms and sirens, TV sets, etc.

According to another aspect of this invention, administrative user can configure remote monitors' notification schedules, alarm types and events, acceptable environmental conditions, including that of temperature ranges using graphical user interface software. Personal Information Management System (PIM) can assist in determining the routing matrices for user commands and notifications, as synchronized with user personal profile information.

### DESCRIPTION OF THE DRAWINGS

The invention is best understood from the following detailed description when read in connection with the accompanying drawings. The various features of the drawings are not to scale, but are reduced or expanded for clarity of the description. Included in the drawings are the following figures:

FIG. 1 is a depiction of the overall exemplary usage and application of the embodiment of the present invention

FIG. 2 is a functional block diagram of the hardware and software architecture of the present invention

FIG. 3 is the diagram of the exemplary hardware interface module as utilized in the method of the present invention during its function of controlling externally connected devices and appliances

FIG. 4 is the diagram of the exemplary hardware interface module as utilized in the method of the present invention during its function of supervising externally connected contact sensors

FIG. 5 is the diagram of the exemplary hardware interface module as utilized in the method of the present invention during its function of supervising externally connected temperature sensors

FIG. 6 is a functional block diagram describing the monitoring and control of remote installation from multiple locations using one of the methods of the present invention

FIG. 7 is a functional block diagram describing monitoring and control of multiple remote location premises using one of the methods of the present invention

FIG. 8 is a functional block diagram of the hardware and software architecture supporting functionality for voice-based remote premises control and monitoring over Skype as another method of the present invention

FIG. 9 is a functional block diagram of the hardware and software architecture supporting functionality for email-based remote premises control and monitoring over Skype as another method of the present invention

FIG. 10 is a functional block diagram of the hardware and software architecture supporting functionality for SMS-based remote premises control and monitoring over Skype as another method of the present invention

FIG. 11 is a functional block diagram of the hardware and software architecture supporting functionality for video capture of the remote events and their transmittal using Skype to monitoring client during remote premises control and monitoring as another method of the present invention

FIG. 12 is a functional block diagram of the hardware and software architecture supporting functionality of using additional display and other user notification devices, alarms and sirens by Home Monitoring and Controlling Proxy application during premises control and monitoring as another method of the present invention

FIG. 13 is an exemplary message structure of the serial control protocol between the Home monitoring and Controlling proxy application and the Hardware Interface Module, subject to this invention.

FIG. 14 is exemplary graphical user interface (GUI) software used for configuration and management of the several software modules and components subject to this invention

FIG. 15 is a functional block diagram of the hardware and software architecture supporting Personal Information Management (PIM)-based routing of user notification and controls during remote premises control and monitoring using Skype as another method of the present invention

FIG. 16 is a functional block diagram of the hardware and software architecture supporting synchronization of Personal Information Management (PIM)-based user database supporting routing of user notification and controls during remote premises control and monitoring using Skype as another method of the present invention

### DETAILED DESCRIPTION OF EMBODIMENTS OF THE INVENTION

Skype application provides to its users a low priced or free instant message (IM) and voice communication services using scalable peer-to-peer paradigm of computer voice, video and text communication. Due to it's high audio quality and highly scalable nature, Skype has a growing number of adopters. Several companies offer services complimentary to Skype, while utilizing Skype communication facility.

Example of such services are avatar services, that present to a remote user a computerized image of the remote party. Another example is additional services that proxy Skype communications to mobile phones and taps into Skype calling-out regular phones feature. Most recently, hardware manufacturers began selling hardware phone extensions to Skype application, for example providing cordless phone extension to a regular computer-based Skype application.

This invention relates to hardware and software device and services that by interfacing with Skype instant message and voice communication facilities provide for remote premises surveillance (e.g., temperature, alarm continuity sensors, other environmental sensors) and for the remote premises-based device control (e.g., garage doors, lights, etc.)

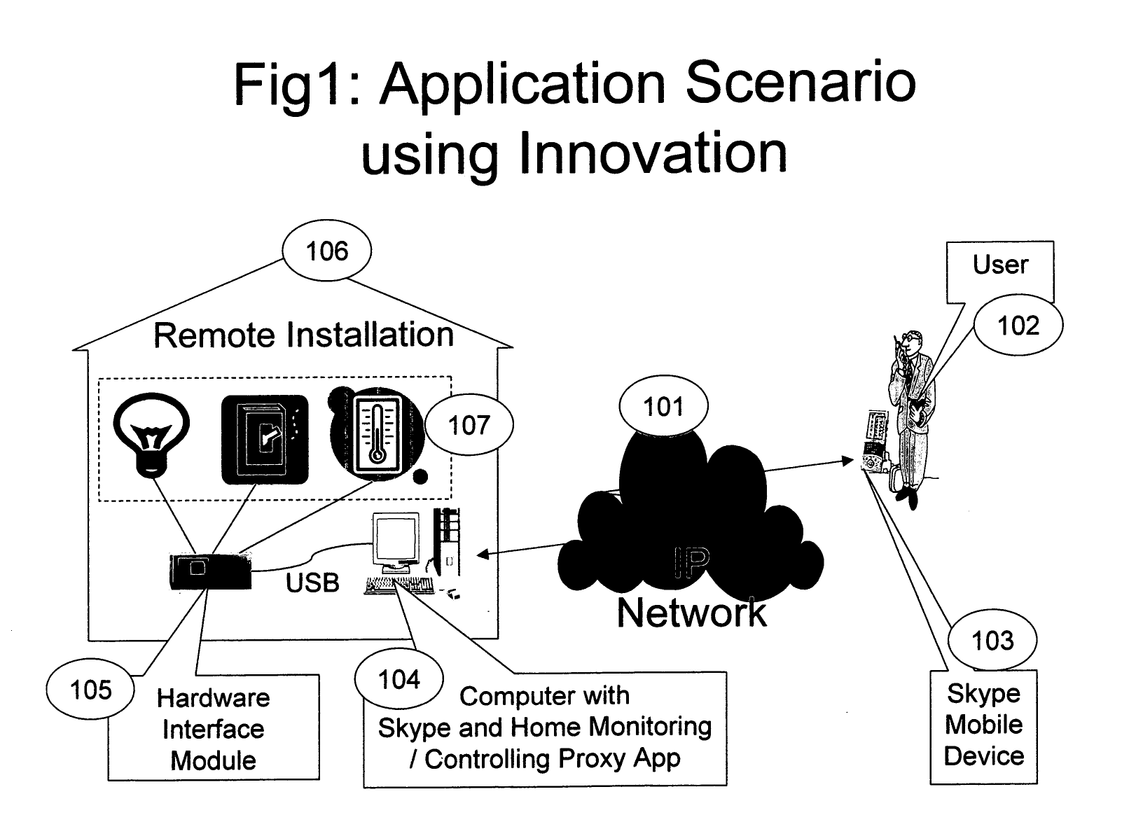

Referring to FIG. 1, a computer 104 residing at some premises 106 has a connected to it hardware interface module 105 subject to this invention. A plurality of environmental sensors and appliances 107 is connected to hardware interface module 105. Hardware interface module can read the status of the sensors 107 as well as instruct appliances to perform a specific function under the control of the Controlling Proxy Application 104.

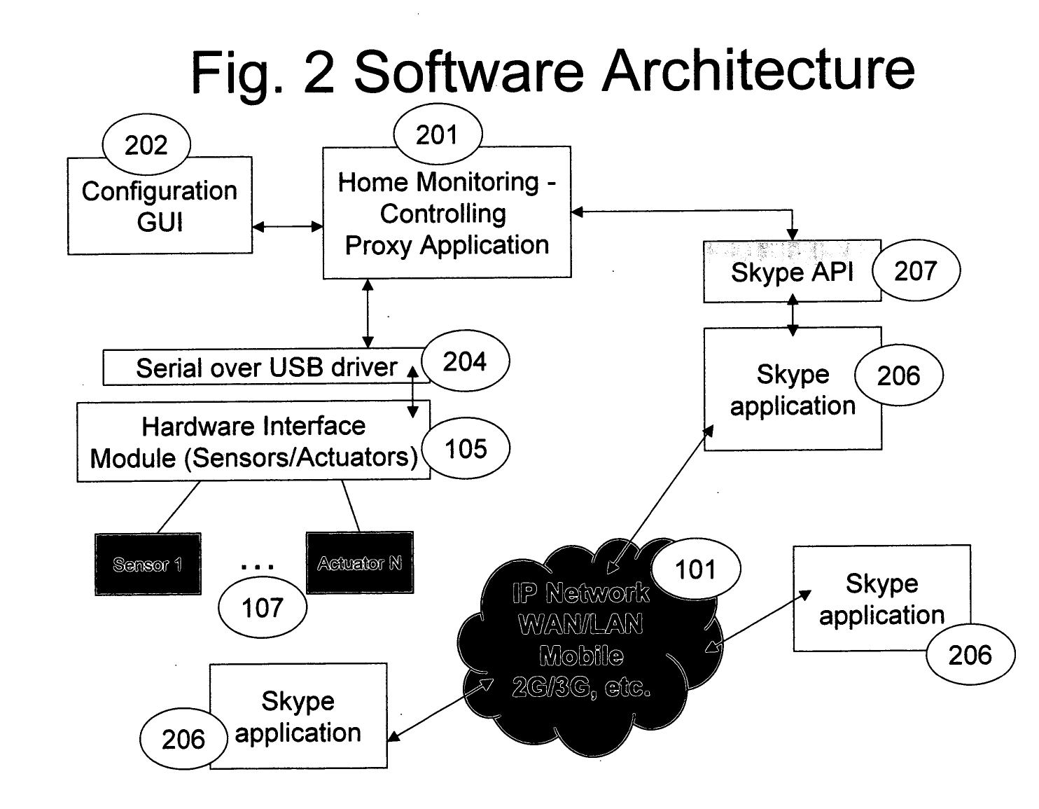

A remote user 102 communicates with computer 104 running Home Monitoring Controlling Proxy application 201 (shown in detail in FIG. 2) via a wide area Internet network 101 by utilizing Skype Communicator application 103 instant messaging and voice communication capability. These messages can flow in both directions. Messages flowing from 102 to 104 are intended for control operation or sensor status inquiry. Messages from 104 to 102 carry status information and control acknowledgement signals.

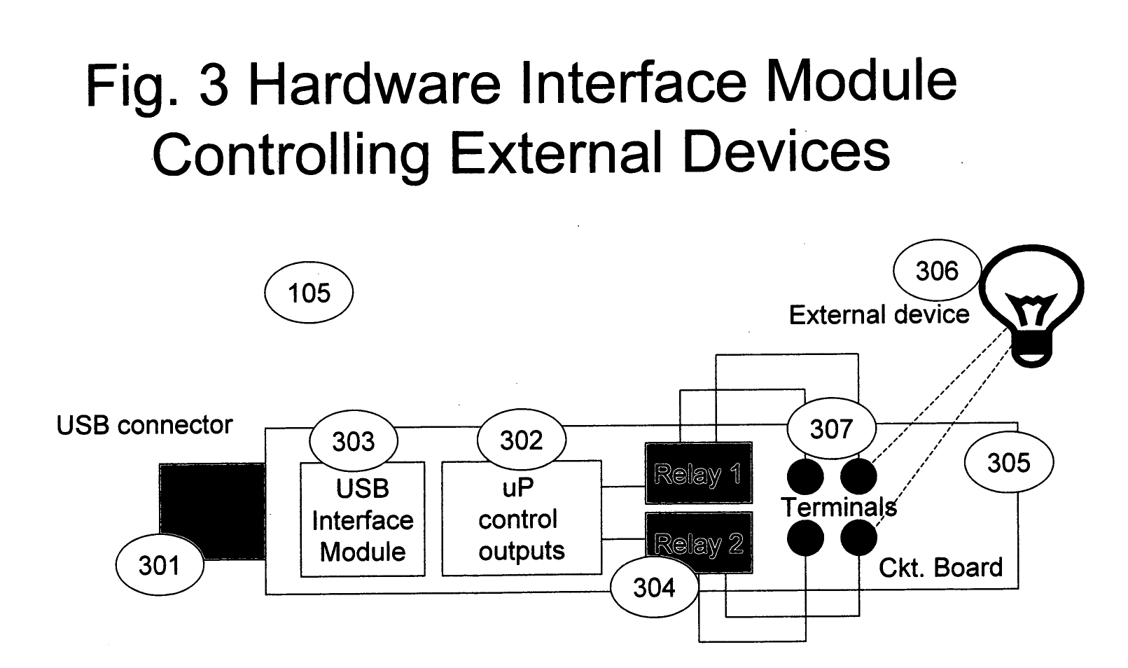

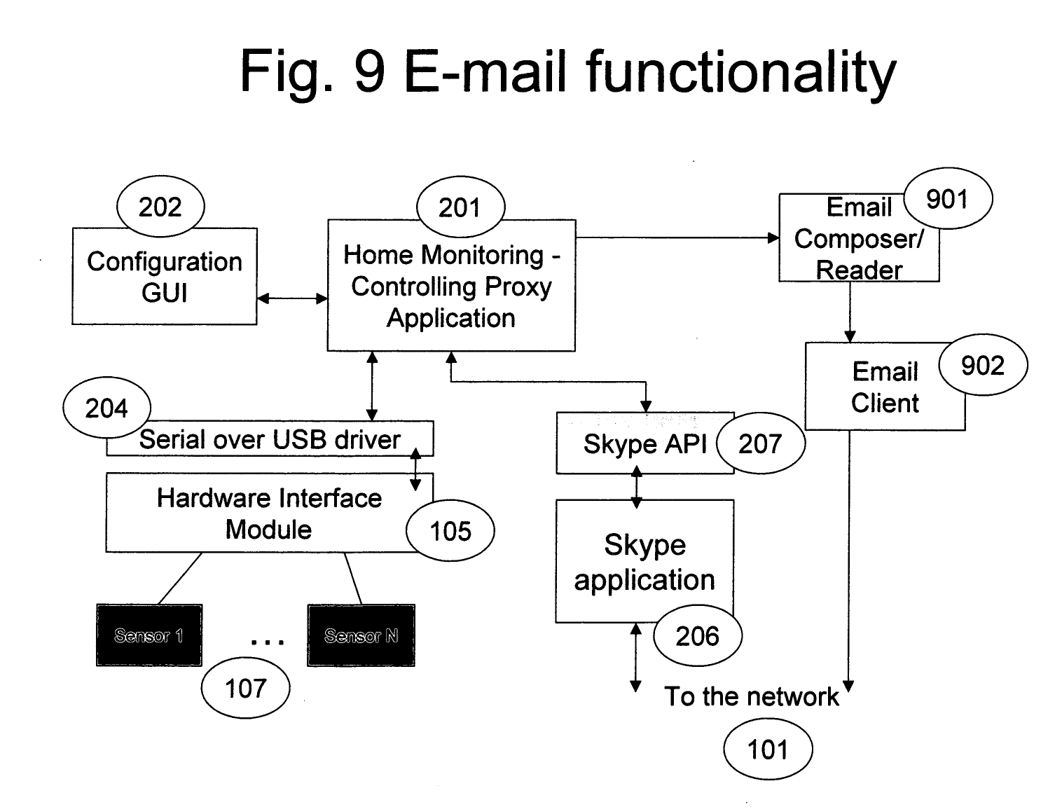

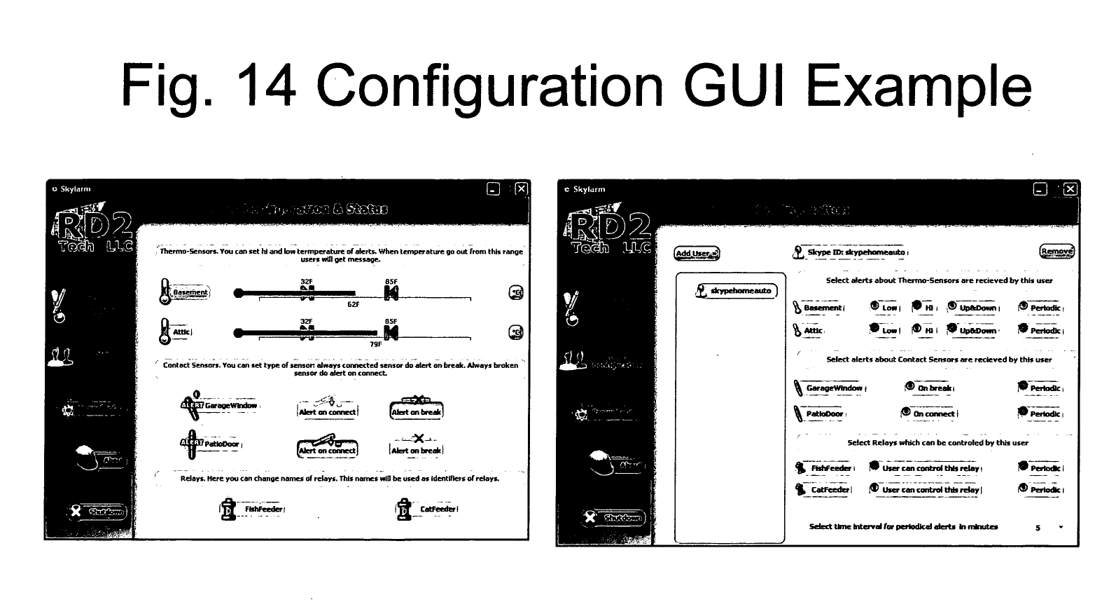

Referring to FIG. 2, hardware interface module 105 is interacting with Home Monitoring and Controlling Proxy application 201 via a serial protocol over USB driver 204. Serial control protocol depicted in FIG. 9 messages are exchanged over 204. Configuration GUI application 202 example of which is depicted in FIG. 14, provides user with ability to setup Skype IDs of the users to be contacted in case of alarm conditions or to configure the events that trigger those alarm conditions in the first place. This GUI also allows user to configure locally remote Skype users who will be authorized to control local devices/actuators as a result of sending messages to the architecture subject of the present invention. As seen in FIG. 2, various sensors (temperature, contact, barometric pressure, water indicator, etc) can be attached to the hardware interface module 105. Hardware interface module depicted in greater detail in FIG. 3 can also be connected to actuators of various kinds (motors, lights, etc). Instant Message (IM) containing control information is sent from remote (mobile) client running Skype application 206 over Skype IM communication channel. Home Monitoring and Controlling Proxy application 201 receives messages via Skype communication channel from remote Skype applications 206 via Skype Application Programming Interface (API) 207 and can instruct hardware interface module 105 to actuate some of these actuators as a result of a specific Skype message received. For example “OPEN 1” Skype IM leads toward hardware interface module closing a relay thus actuating external motor to open the garage door 1.

Various Skype users can have different degree of authority to execute various remote control instructions leading to control/actuation of a plurality of local actuators.

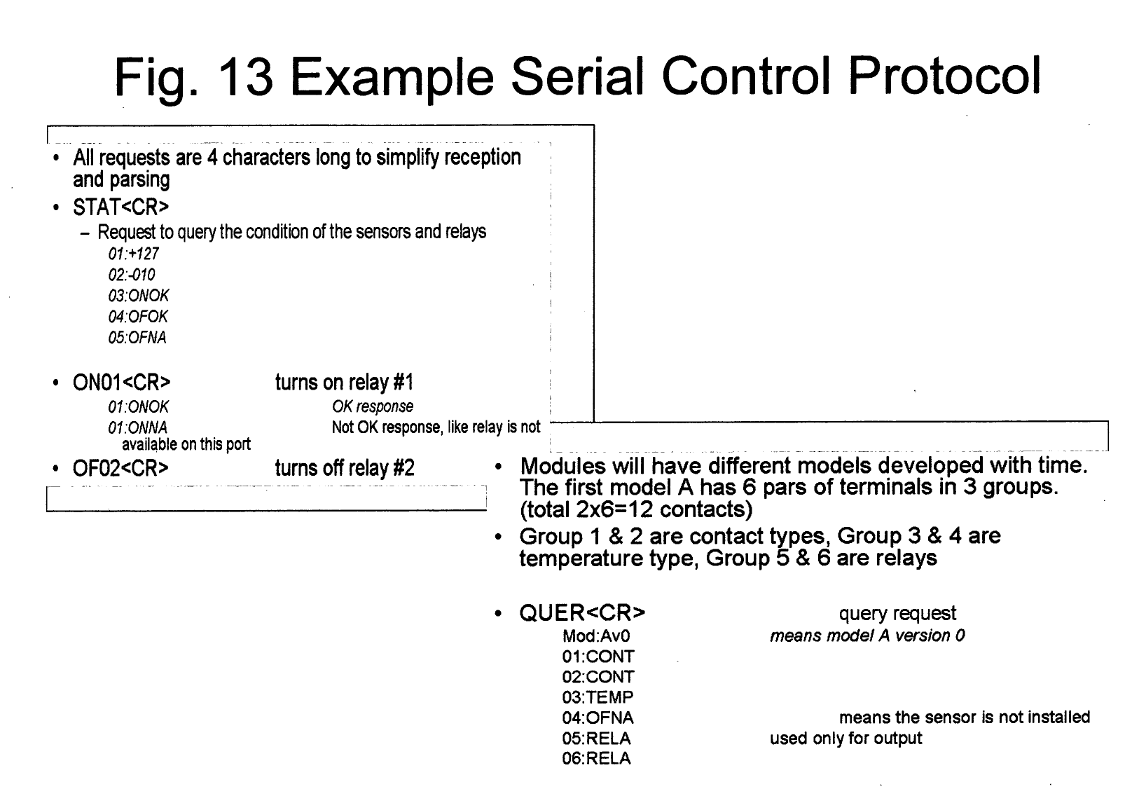

Referring now to FIG. 3, a sample hardware interface module 105 may contain several terminals 307 for external device/actuator connections 307. Built-in microcontroller with outputs 302 translates instructions received over USB interface 301 using serial control protocol depicted in FIG. 13 by means of communication via USB interface module 303 into the voltage levels directly controlling relays 304 (mechanical/electronic) which directly actuate external devices 306 (e.g., lights, garage doors). So the reception of Skype IM “open 1”, for example, causes relay one to go from closed state to open state. Low voltage relays 304 can be used to control more powerful relays for more power-consuming appliances and devices.

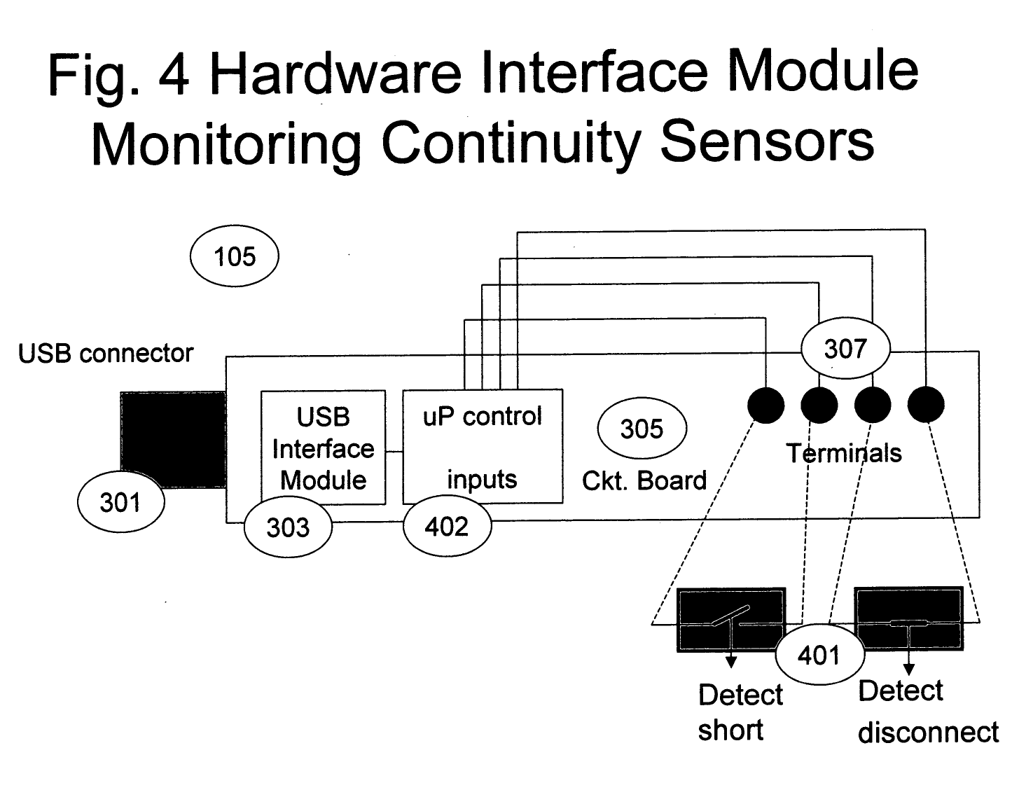

Referring now to FIG. 4, a sample hardware interface module 105 may contain several terminals 307 for connection of external continuity sensors 401, capable of detecting open circuit or short circuit conditions. Such sensors are used widely in alarm applications. Microprocessor inputs are fed with the status information from these sensors, and then translated into appropriate status messages received by Home Monitoring and Controlling Proxy application 201 over USB interface 301 using serial control protocol depicted in FIG. 13 by means of communication via USB interface module 303. Having this type of connectivity, Home Monitoring and Controlling Proxy application 201 can generate alarm message to be sent to Skype API 207 in case alarm condition is detected by 401 sensors.

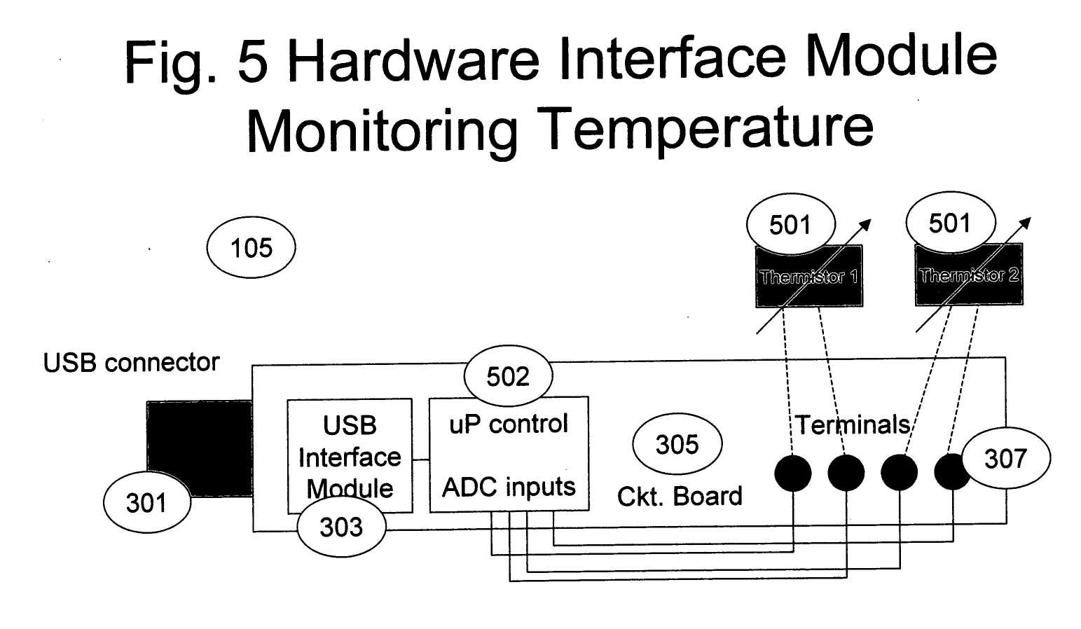

Referring now to FIG. 5, a sample hardware interface module 105 may contain several terminals 307 for connection of external temperature sensors 501. These sensors are connected using proper electrical interfaces to analog to digital (ADC) conversion inputs of the microcontroller (uC) 502. Microcontroller computes the temperature reported by 501 placed at several locations near 105, and then translated these temperature numbers into appropriate status messages received by Home Monitoring and Controlling Proxy application 201 over USB interface 301 using serial control protocol depicted in FIG. 13 by means of communication via USB interface module 303. Having this type of inter-connectivity, Home Monitoring and Controlling Proxy application 201 can generate alarm message to be sent to Skype API 207 in case temperature-related alarm condition is detected by 501 sensors.

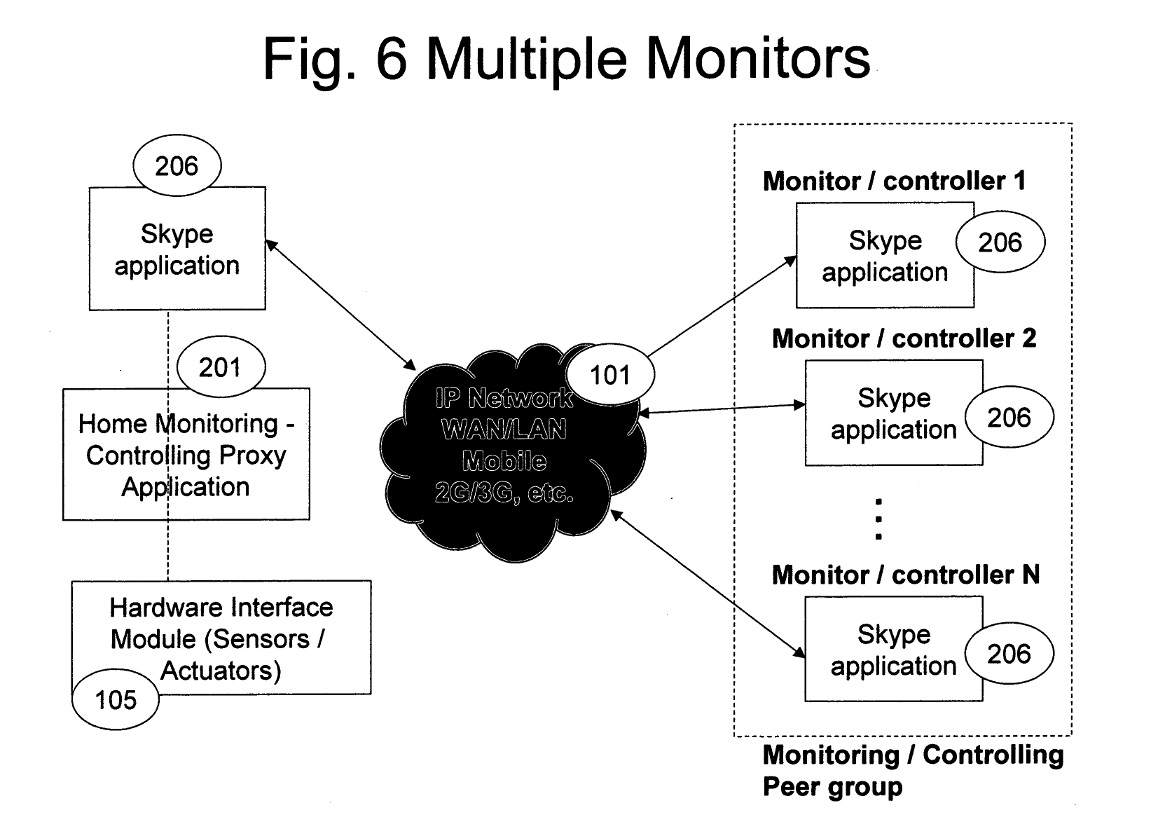

As shown in FIG. 6, a plurality of Skype application-based monitoring applications 206 can be instantiated and connected via network 101 to Skype application 206 residing at the premises to be monitored. Home Monitoring and Controlling Proxy application 201 interfaces to 206 and 105 at that location. Home Monitoring and Controlling Proxy application 201 then notifies all 206 according to user and event configuration lists configurable via Configuration GUI 202, also shown in FIG. 14.

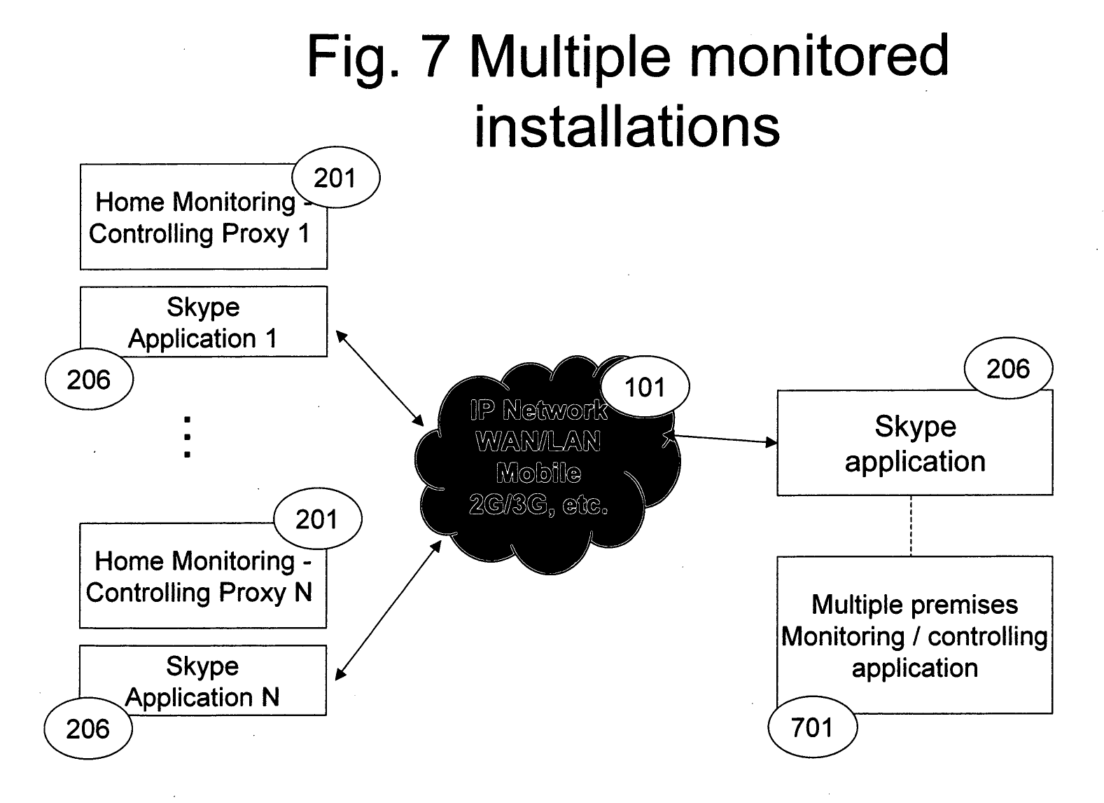

Referring now to FIG. 7, a plurality of Home Monitoring and Controlling Proxy applications 201 interfaced to Skype applications 206 can be instantiated at different locations subject to remote monitoring and control. Multiple premises monitoring and controlling application 701 interacts via Skype API with plurality of Skype applications 206, represented by different Skype IDs. Alarm conditions from multiple installations of 201 can be aggregated, and controlling messages from 701 can be dispatched to appropriate Home Monitoring and Controlling Proxy applications 201 causing necessary actuator/appliance control injected by the hardware interface modules 105.

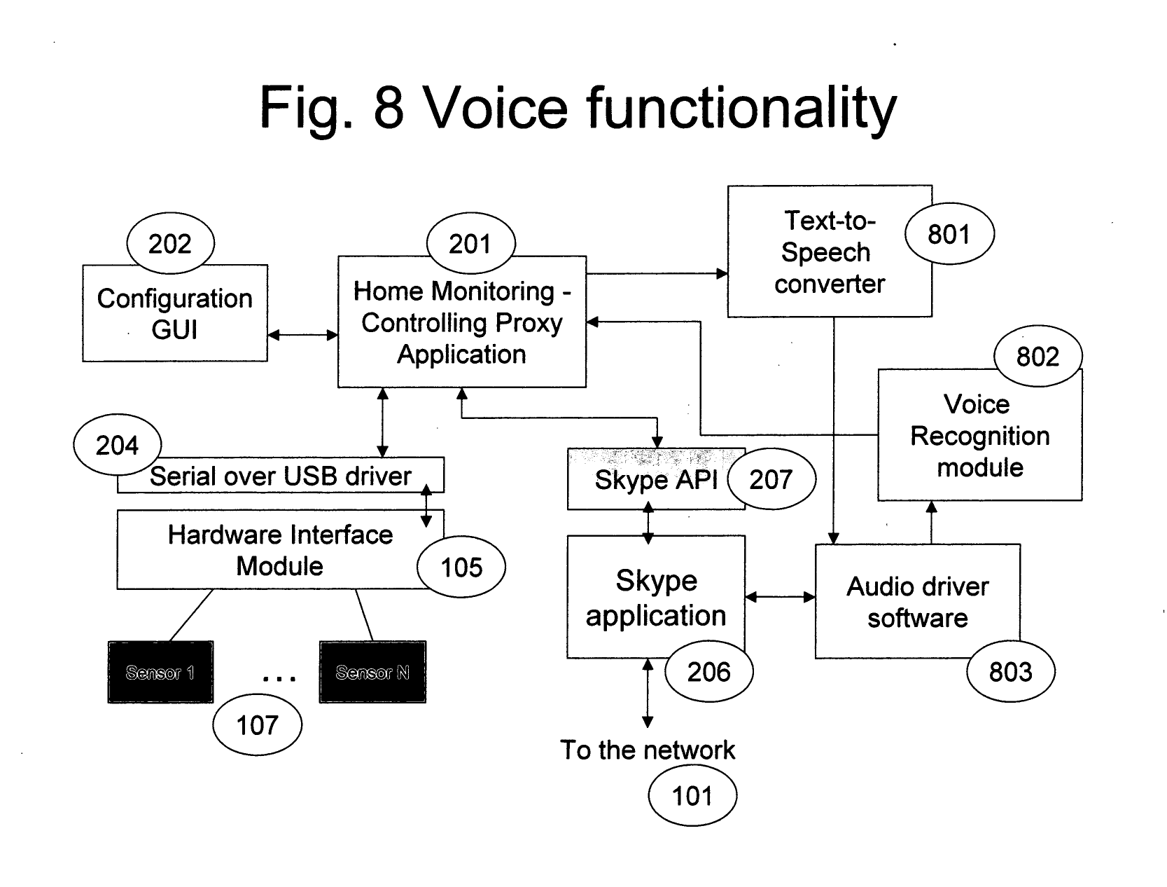

Referring now to FIG. 8, in another aspect of this invention, user voice-driven monitoring and control are realized by combining Home Monitoring and Controlling Proxy application 201, GUI 202, component 204 and hardware interface module 105 with text-to-speech converter 801 and Voice recognition (VR) module 802. Audio software driver 803 interfaces 802 and 801 with Skype voice communication channel. Voice recognition module 802 translates voice commands received over Skype from the remote user into the appropriate control signals to be issued by 201 to 105 within the controlled and monitored premises. Remote user can say “Turn on Light”. 802 translates this command into a textual command “Turn on light”, causing 201 to translate it into “Turn On 1” instruction issued over 204, subsequently causing 105 to close the corresponding relay output 304. Similarly, temperature reading from 105 can be translated by 201 into a text string “Temperature in the Bedroom is 75 degrees”, causing 801 to issue a voice prompt over Skype voice channel with the same content.

Similarly, as shown in FIG. 9 interfacing email composer/reader application 901 with email client 902 and components 201, 204, 105, 202, 207 and 206, allows Home monitoring and controlling proxy application 201 to respond to the received emails with proper commands issued to 105, or to generate textual information for 901 as a result of some sensory input reading. The registered via GUI 202 client can receive email-based notification as a result of some monitored event.

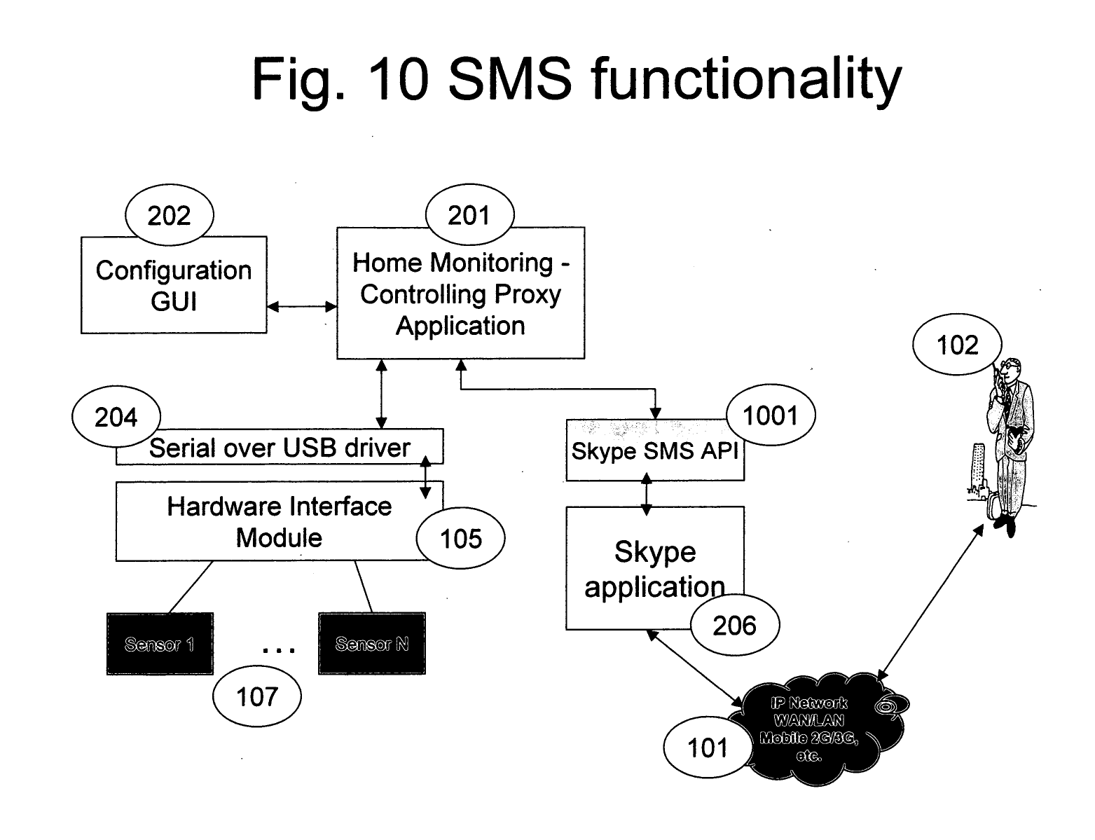

Referring now to FIG. 10, Skype Short Message Service (SMS) API can be used by Home Monitoring and Controlling Proxy Application 201 to generate SMS status messages directed at any mobile client (client does not have to be equipped with the Skype capability in this case). SKYPEIN and SKYPEOUT Skype paid services are used in conjunction with Skype application 206 to relate those SMS via the corresponding mobile networks to the user. This method of the innovation also provides for capability of receiving SMS messages from the controlling mobile users and translating them into the appropriate command issued to interface 105 by proxy 201.

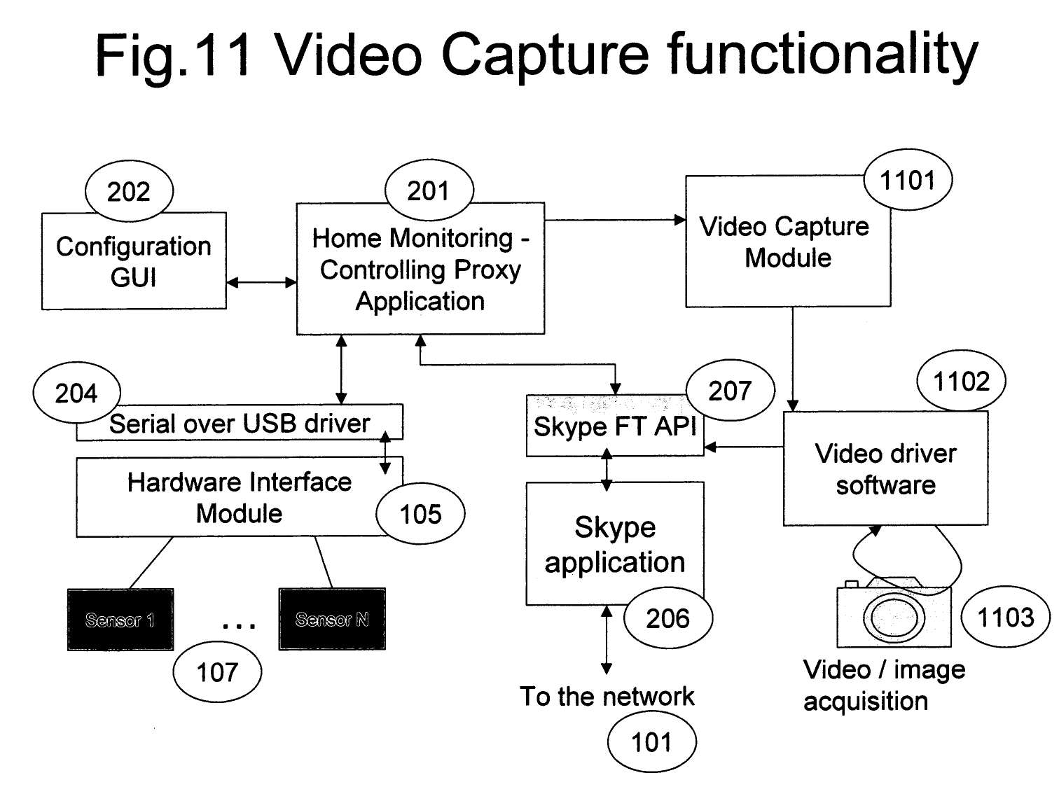

Referring now to FIG. 11, in another aspect of this innovation, locally occurring alarm event or the received over Skype remote user instruction can trigger an acquisition of the surveillance video of the premises by the Video Capture module 1101 by invoking the video driver software 1102 and video camera 1103. The resultant video file can then be transmitted to the remote user of the system via Skype File Transfer (FT) API 207 under the control of 201 Home Monitoring and Controlling Proxy.

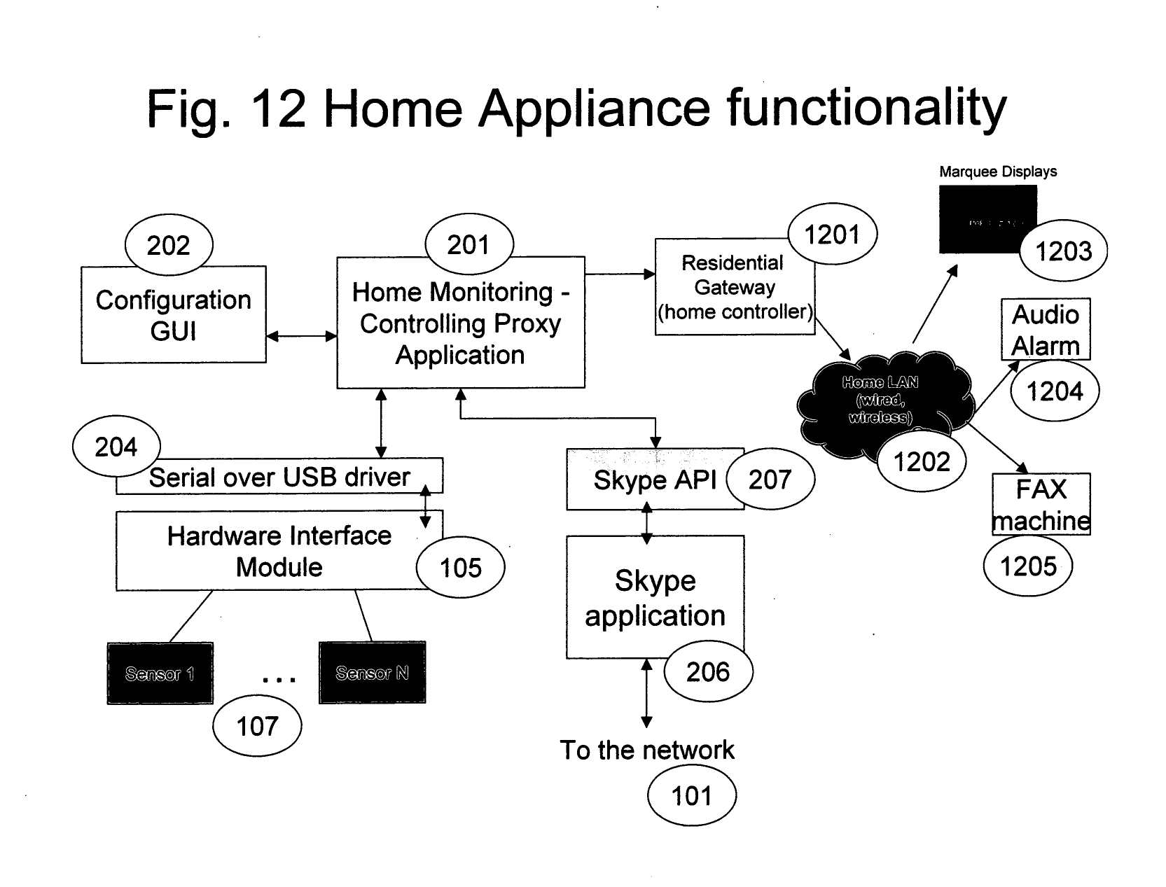

As shown in FIG. 12, the method of the present invention also provides for the capability to support a number of externally-connected internet-based home appliances for the purpose of disseminating status events, messages and controls within the premises. Home Monitoring and Controlling Proxy 201 interconnects to these appliances via Home residential Gateway 1201 in a fashion readily understood by one skilled in the art of home networking. Text messages received over Skype from remote users or locally from hardware interface module 105 can thus be sent by 201 to marquee displays 1203, audible sirens 1204 or internet-based fax machines 1205 located anywhere within the reach of internet connectivity with 201.

As noted earlier, FIG. 13 shows an example serial control protocol exchanged between Home Monitoring and Controlling Proxy 201 and Hardware interface module 105 via serial over USB driver 204. Query-Response type of exchange invoked in polling mode by 201 assures timely communication of status of externally connected sensors or commands to externally connected appliances. The protocol shown is for illustrative purposes only, and can be easily substituted by one proficient in the art for another protocol providing for the functionality of interfacing 105 and 201.

Referring now to FIG. 14, an example graphical user interface (GUI) software 202 is shown. This GUI 202 allows the administrative user to configure Home Monitoring and Controlling Proxy 201 with the names of remote Skype IDs serviceable by 201. It also allows local or remote administrators to configure the nature of alarms, status reports to remote users, access privileges for device control by remote users, etc. Temperature ranges violating the normal temperature conditions and subsequently generating alarms and status reports can be configured, for example.

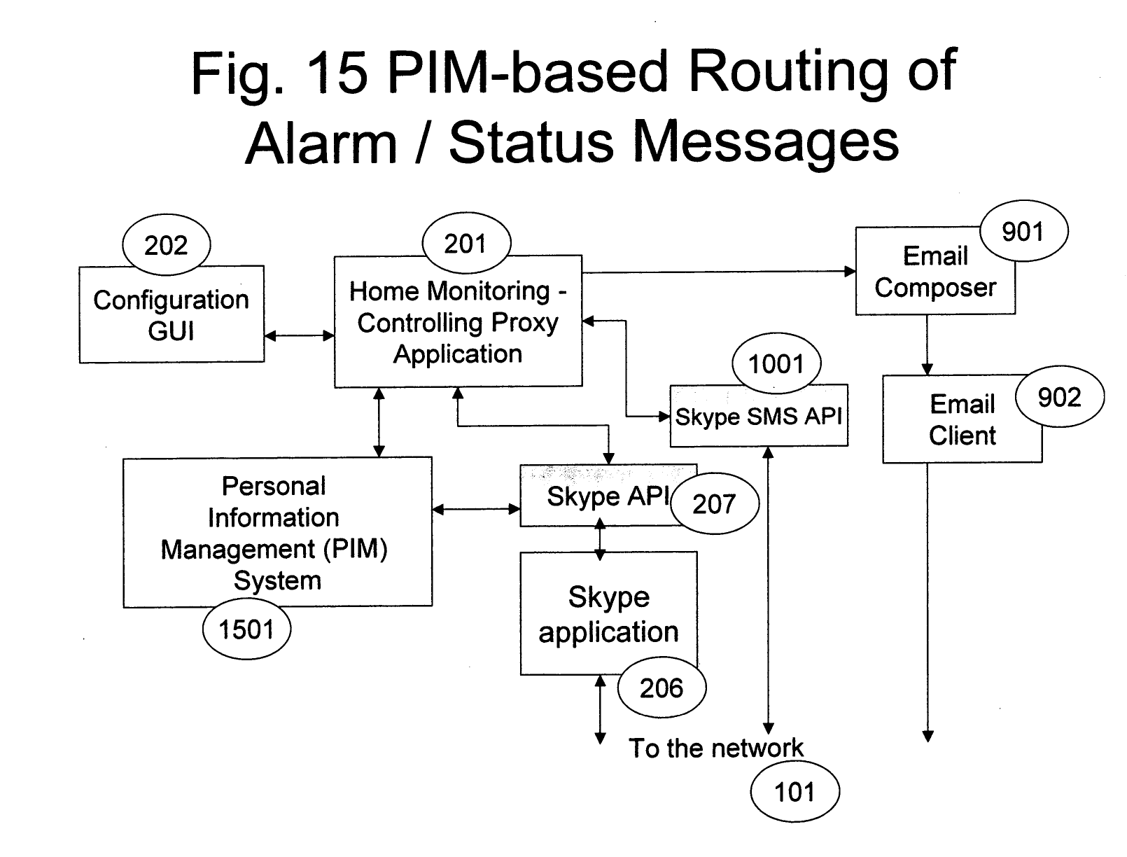

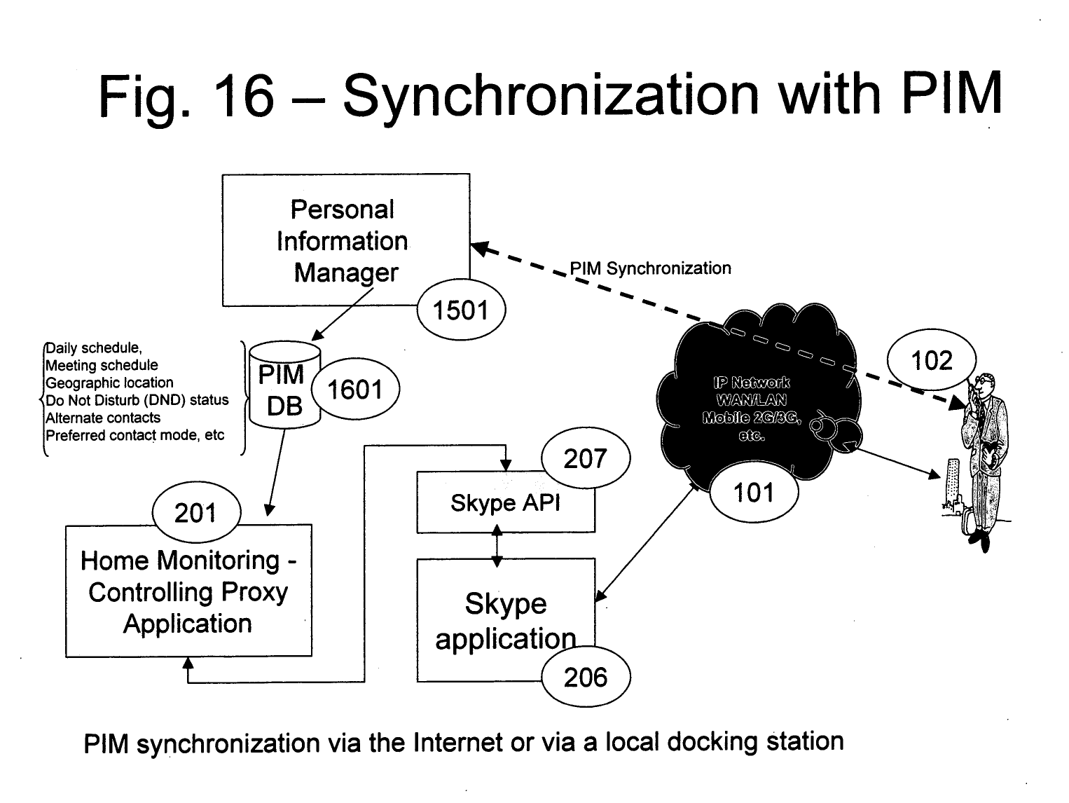

As shown in FIG. 15, Home Monitoring and Controlling Proxy 201 having a plurality of message routing options (i.e., Skype API 207, Skype SMS API 1001, email 901, residential internet gateway 1201, etc.) can consult Personal Information management (PIM) system 1501 for the most up-to-date location profile for the remote user 102 of the system. As further shown by FIG. 16, this user profile including user daily schedules, alternative contact information, etc. can be stored in PIM database 1601 and synchronized by PIM 1501 with remote user 102 by state of the art PIM synchronization protocols over IP network 101.

1. A method for remote premises monitoring and control comprising from monitoring and controlling proxy application interfaced with Skype client software, user-driven proxy-configuration graphical user interface and hardware interface module; with said proxy performing the functions of:
observing the status of external sensors via hardware interface module,
exerting control signals onto external devices connected via the hardware interface module according to instructions received from remote client via Skype interface,
communicating with remote user via Skype application communication channel facilities, including that of text or instant messages,
whereas said hardware interface module is interconnected with said sensors and actuators using appropriate hardware signal interfaces.

2. A method of remote premises monitoring and control comprising of instantiating a plurality of Skype-based clients and/or control and monitoring applications communicating using Skype with a single instantiation of method of claim 1 during the control and monitoring of the remote installation with said instantiation from multiple locations, whereas such client locations are mobile or stationary.

3. A remote monitoring and control architecture comprising from a plurality of instantiations of method of claim 1 communicating with a remote user's Skype client and/or control and monitoring applications communicating using Skype over a wide or a local area network and in so doing achieving the monitoring and control of multiple premises' locations by a remote user.

4. A method of multiple remote premises monitoring and control comprising of instantiating a plurality of Skype-based clients and/or control and monitoring applications communicating using Skype and comprising of multiple instantiations of method of claim 1 during the control and monitoring of multiple remote installations with said instantiations from multiple user locations.

5. A method for remote premises monitoring comprising of method of claim 1 where sensory data and generated status and alarm messages include or based upon the temperature measurements obtained from a plurality of temperature sensors connected to the hardware interface module of claim 1.

6. A method for remote premises monitoring comprising of method of claim 1 where sensory data and generated status and alarm messages include or based upon the connectivity measurements obtained from a plurality of electric connectivity sensors connected to the hardware interface module of claim 1.

7. A method for remote premises monitoring and control comprising from monitoring and controlling proxy application interfaced with Skype client software, user-driven proxy-configuration graphical user interface, hardware interface module, text to speech converter application module, and voice recognition application module, with said modules performing the functions of:
observing the status of external sensors via hardware interface module,
exerting control signals onto external devices connected via the hardware interface module according to instructions received from remote client via Skype interface,
communicating with remote user via Skype application communication channel facilities, including that of voice and text instant messages,
translating sensor status and alarm conditions received from the hardware interface module into voice prompts to be sent over Skype communication channels,
translating voice instructions and commands received via Skype from the remote users into proxy's instructions and status acknowledgements sent to hardware interface module,
whereas said hardware interface module is interconnected with said sensors and actuators using appropriate hardware signal interfaces.

8. A method of remote premises monitoring and control comprising of instantiating a plurality of Skype-based clients and/or control and monitoring applications communicating using Skype with a single instantiation of method of claim 7 during the control and monitoring of the remote installation with said instantiation from multiple locations, whereas such client locations are mobile or stationary.

9. A remote monitoring and control architecture comprising from a plurality of instantiations of method of claim 7 communicating with a remote user's Skype client and/or control and monitoring applications communicating using Skype over a wide or a local area network and in so doing achieving the monitoring and control of multiple locations by a remote user.

10. A method of multiple remote premises monitoring and control comprising of instantiating a plurality of Skype-based clients and/or control and monitoring applications communicating using Skype and comprising of multiple instantiations of method of claim 7 during the control and monitoring of multiple remote installations with said instantiations from multiple user locations.

11. A method for remote premises monitoring and control comprising of method of claim 7 with additional capability of translating status, command and control SMS received or sent over “Skype IN” and “Skype OUT” communication interfaces by means of Home Monitoring Controlling proxy application interfacing with Skype SMS application programming interface.

12. A method for remote premises monitoring and control comprising of method of claim 1 with additional capability of translating status, command and control SMS received or sent over “Skype IN” and “Skype OUT” communication interfaces by means of Home Monitoring Controlling proxy application interfacing with Skype SMS application programming interface.

13. A method for remote premises monitoring and control comprising of method of claim 1 with Home Monitoring and Controlling proxy application module dispatching sensor status and alarm messages according to the remote user routing metrics stored within Personal Information Management (PIM) System, including that of remote Skype user selection based on time of day, security policy, remote user current geographical location.

14. A method for remote premises monitoring and control comprising of method of claim 7 with Home Monitoring and Controlling proxy application module dispatching sensor status and alarm messages according to the remote user routing metrics stored within Personal Information Management (PIM) System, including that of remote Skype user selection based on time of day, security policy, remote user current geographical location.

15. A method for remote premises monitoring and control comprising of method of claim 1 with Home Monitoring and Controlling Proxy Application module dispatching email message by utilizing the functions of Email composer and Email Client modules, and including sensory status and alarm event information within the body of those email messages.

16. A method for remote premises monitoring and control comprising of method of claim 7 with Home Monitoring and Controlling Proxy Application module dispatching email message by utilizing the functions of Email composer and Email Client modules, and including sensory status and alarm event information within the body of those email messages.

17. A method for remote premises monitoring and control comprising of method of claim 1 with Home Monitoring and Controlling Proxy Application module triggering video capture application module into a video acquisition mode upon detecting sensory status change or upon receiving corresponding message from a remote Skype user by means of Skype communication channels, with said video capture module further sending obtained video payload data to a remote Skype monitoring user by means of Skype communication channels.

18. A method for remote premises monitoring and control comprising of method of claim 7 with Home Monitoring and Controlling Proxy Application module triggering video capture application module into a video acquisition mode upon detecting sensory status change or upon receiving corresponding message from a remote Skype user by means of Skype communication channels, with said video capture module further sending obtained video payload data to a remote Skype monitoring user by means of Skype communication channels.

18. A method for remote premises monitoring and control comprising of method of claim 1 with Home Monitoring and Controlling Proxy Application module triggering communication over Skype SMS (Short Message Service) application programming interface upon determining the “offline” Skype status of a remote Skype monitoring user, with said Home Monitoring and Controlling Proxy Application switching back to a regular Skype communication channel (i.e., voice or IM) upon detecting the “online” Skype status of a remote Skype monitoring user.

19. A method for remote premises monitoring and control comprising of method of claim 1 with Home Monitoring and Controlling Proxy Application module dispatching textual and graphical messages, including that but no limited to status and alarm messages to external display devices and internet appliances interconnected using serial or TCP/IP type of connectivity via residential internet gateway.

20. A method for remote premises monitoring and control comprising of method of claim 7 with Home Monitoring and Controlling Proxy Application module dispatching textual and graphical messages, including that but no limited to status and alarm messages to external display devices and internet appliances interconnected using serial or TCP/IP type of connectivity via residential internet gateway.
